(19) United States
(12) Patent Application Publication
(10) Pub. No.: US 2025/0029027 A1
(43) Pub. Date: Jan. 23, 2025

(54) SIMULATION SYSTEM AND COMPUTER-READABLE MEDIUM

(71) Applicant: TOYOTA JIDOSHA KABUSHIKI KAISHA, Aichi-ken (JP)

(72) Inventors: Takahiro SAKURAI, Nagoya-shi (JP); Masafumi KADOI, Chita-shi (JP); Shigefumi TOKUDA, Susono-shi (JP); Kensuke MATSUMOTO, Nagoya-shi (JP); Takumi BAN, Setagaya-ku (JP); Yoshio TAKIZAWA, Nagoya-shi (JP); Ambi SHO, Nisshin-shi (JP); Tomoyuki KAGA, Mishima-shi (JP); Hideo HASEGAWA, Nagoya-shi (JP); Kenta MIYAHARA, Edogawa-ku (JP); Shinsuke YAMAUCHI, Toyota-shi (JP)

(21) Appl. No.: 18/766,652

(22) Filed: Jul. 9, 2024

(30) Foreign Application Priority Data
Jul. 19, 2023 (JP) 2023-117500

(51) Int. Cl. G06Q 10/0631

(52) U.S. Cl. CPC G06Q 10/06311

(57) ABSTRACT

A digital twin simulation is executed. In this simulation, a personal relationship level between two workers included in multiple workers is calculated. Further, based on the personal relationship level between the two workers and data of work content of the work scheduled to be executed in a work line of a real space, an assignment pattern of workers satisfying a reference condition in which a work efficiency in a whole work line of a digital space is equal to or greater than a target value is searched.

### CROSS-REFERENCE TO RELATED APPLICATION

The present application claims priority under 35 U.S.C. § 119 to Japanese Patent Application No. 2023-117500, filed on Jul. 19, 2023, the contents of which application are incorporated herein by reference in their entirety.

### TECHNICAL FIELD

The present disclosure relates to a system and a computer-readable medium for performing simulation related to a work line.

### BACKGROUND

JP202057176A discloses a system for creating a work schedule of a service for maintenance, repair and other works for a building equipment. The system in the related art generates compatibility data of personal relationship among workers based on evaluation data of a worker in charge of the service with respect to other workers. The work schedule is created based on the compatibility data. Specifically, the work schedule is generated such that a worker who is engaged in a certain service and a worker who is compatible with the worker are combined.

Examples of the documents showing the technical level in the technical field related to the present disclosure include WO2014083656A, in addition to JP202057176A.

In the system of the related art, the evaluation data is generated by the worker inputting an evaluation for other worker to an information terminal. Therefore, when the evaluation for other worker is not input, the evaluation data is not generated, and the compatibility data is not generated. Further, the evaluation of another worker tends to be subjective to the evaluator. Therefore, there is a possibility that the work schedule including the combination of the workers having good compatibility is prevented from being created.

In particular, in a work line in which multiple works are cooperatively performed by multiple workers, an increase or decrease in work efficiency due to the personal relationship among these workers affects the work efficiency in a whole work line. Therefore, there is room for development from this aspect.

An object of the present disclosure is to provide a technique capable of increasing the work efficiency in the whole work line in which the multiple works are cooperatively performed by the multiple workers, in consideration of personal relationship between the workers.

### SUMMARY

A first aspect of the present disclosure is a simulation system and has the following features.

The simulation system includes a database and a processing circuitry. The database stores data of multiple workers arranged in a work line of a real space. The processing circuitry is configured to execute a simulation on a work line of a digital space corresponding to that of the real space based on data of a work plan in the work line of the real space and data stored in the database.

The data of the multiple workers stored in the database includes data of personal attributes of the multiple workers and data of a personal relationship level between two workers included in the multiple workers, the data of the personal relationship level being calculated based on the data of the personal attributes.

The data of the work plan in the work line of the real space includes data of work contents of works scheduled to be performed in the work line of the real space.

In the simulation, the processing circuitry is configured to search for an assignment pattern of workers satisfying a reference condition in which a work efficiency in a whole work line of the digital space is equal to or greater than a target value, based on the data of the work contents of works to be performed and data related to the personal relationship level between the two workers.

A second aspect of the present disclosure is a non-transitory computer-readable medium storing a simulation program and has the following features.

The simulation program causes a computer to execute a simulation in a work line of a digital space corresponding to a work line of a real space.

In the simulation, an assignment pattern of workers satisfying a reference condition that a work efficiency in a whole work line of the digital space is equal to or more than a target value is searched for based on data of work contents of works scheduled to be performed in the work line of the real space and data of a personal relationship level between two workers included in multiple workers arranged in the work line of the real space, the data of the work contents being calculated based on data related to personal attributes of the multiple workers.

According to the present disclosure, the simulation is executed for the work line in the digital space corresponding to the work line in the real space. In this simulation, the personal relationship level between two workers included in the multiple workers is calculated. Further, based on the personal relationship level between two workers and the data of the work contents of the work scheduled to be performed in the work line of the real space, the assignment pattern of the worker satisfying the reference condition in which the work efficiency in the whole work line of the digital space is equal to or greater than the target value is searched. According to the assignment pattern of the worker satisfying the reference condition, when the work line of the real space is operated based on the assignment pattern, it is expected that the work efficiency in the whole work line is increased. Therefore, according to the present disclosure, in the work line in which the multiple works are cooperatively performed, it is possible to the increase work efficiency in a whole work line in consideration of the personal relationship among these workers.

### BRIEF DESCRIPTION OF DRAWINGS

FIG. 1 is a diagram for illustrating an example of a work line to which an embodiment of the present disclosure is applied;

FIG. 2 is a diagram for illustrating a calculation example of an index related to a work efficiency of a worker;

FIG. 3 is a diagram for illustrating an outline of a simulation according to the embodiment;

FIG. 4 is a diagram for illustrating a configuration example of a simulation system according to the embodiment; and

FIG. 5 is a diagram for illustrating a configuration example of worker data.

### DESCRIPTION OF EMBODIMENT

Hereinafter, embodiments of the present disclosure will be described with reference to the drawings. In the drawings, the same or corresponding parts are denoted by the same reference numerals, and the description thereof will be simplified or omitted.

### 1. Work Line

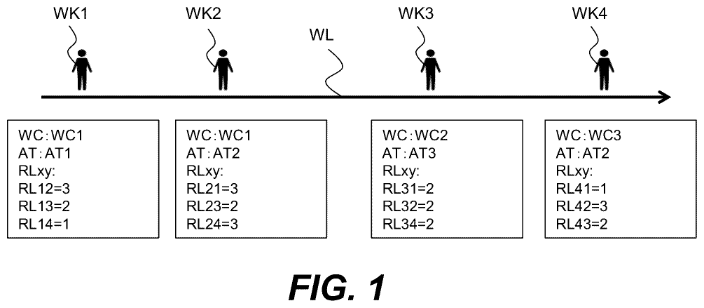

FIG. 1 is a diagram for illustrating an example of a work line to which an embodiment of the present disclosure is applied. The work line WL depicted in FIG. 1 is a line for cooperatively performing various operations such as production, storage, and packaging of products. The work line WL is provided in a site of a factory that mass-produces products, in a site of a distribution warehouse that stores products and raw materials thereof or packs and ships products, and in a site of a distribution center that receives, inspects, stores, picks, packs, and ships products.

Multiple workers are arranged in the work line WL. These workers are engaged in various kinds of work performed in cooperation with each other in the work line WL. Workers WK1, WK2, WK3, and WK4 shown in FIG. 1 are examples of the multiple workers arranged on the work line WL. The workers WK1 and WK2 are engaged in the work of a work content WC1. The worker WK3 is engaged in the work of a work content WC2, and the worker WK4 is engaged in the work of a work content WC3. Hereinafter, for convenience of description, when any one of the multiple workers is referred to, the worker is also referred to as a “worker WKx”.

Also shown in FIG. 1 is the personal attribute AT of the worker WKx. The personal attribute AT is determined by using attributed elements including public attributes such as the position, the number of years of work, and the type of employment of the worker WKx in the organization managing the work line WL, and private attributes such as age, sex, family structure, home address, and hometown. In the example shown in FIG. 1, the personal attribute AT of the worker WK1 is AT1, the personal attribute AT of the worker WK2 is AT2, and the personal attribute AT of the worker WK3 is AT3. The personal attribute AT of the worker WK4 is the same as that of the worker WK2.

In FIG. 1, a personal relationship level RLxy is further shown. The personal relationship level RLxy represents a level of a personal relationship Rxy between the worker WKx and another worker WKx (hereinafter, also referred to as a “worker WKy”). Hereinafter, the personal relationship Rxy is simply referred to as a “relationship Rxy”, and the personal relationship level RLxy is simply referred to as a “relationship level RLxy”.

For example, the relationship level RLxy indicates a higher value as the relationship Rxy between the worker WKx and the worker WKy is recognized as a better relationship. The relationship Rxy being a relationship recognized as favorable may be a relationship recognized as favorable at present or a relationship expected to be favorable in the future. In the example shown in FIG. 1, the relationship level RLxy is divided into three levels. When the worker WKx is the worker WK1 (that is, x=1), the relationship level RL1y is RL12=3 (y=2), RL13=2 (y=3), and RL14=1 (y=4).

In FIG. 1, the relationship level WK2 when worker WKx is worker RL2y (i.e., x=2), relationship level WK3 when worker WKx is worker RL3y (i.e., x=3), and relationship level WK4 when worker WKx is worker RL4y (i.e., x=4) are each shown in three levels. The value of the relationship level RLxy between the worker WKx and the worker WKy is equal between (x, y)=(1, 2) and (x, y)=(2, 1). That is, when the numerical value of x and the numerical value of y are replaced, the value of the relationship level RLxy before the replacement and the value after the replacement are equal to each other.

### 2. Features of Embodiment

In the embodiment, simulation using a digital space (hereinafter, also referred to as a “digital twin simulation” or an “DTS”) is executed. The digital space is reproduced based on a real space in which the work line WL described in FIG. 1 is provided. In the DTS, various kinds of work that are the same as the various kinds of work performed in the work line WL of the real space are performed in the digital space, and a future state in the work line WL is predicted. The future state includes a work efficiency WE_WWL of the entire work line WL.

As a factor that affects the work efficiency WE_WWL, a work efficiency WE_WKx of the worker WKx is assumed. Further, as factors affecting the work efficiency WE_WKx, work content WC_WKx of a work in which the worker WKx is engaged, the relationship Rxy, and the like are assumed. For example, when there is a relation between the work content WC_WKx and the work content WC_WKy of the work in which the worker WKy is engaged, the relation Rxy affects the work efficiency WE_WKx. As a case where the work content WC_WKx and the work content WC_WKy are related to each other, a case where these work content WC are the same is exemplified. As another example, there is a case where the work content WC_WKx and the work content WC_WKy are different from each other, but the work content WC are to be continuously executed, for example, one work content WC is executed immediately after the other work content WC is executed.

In the DTS according to the embodiment, the index IN_WE_WKx related to the work efficiency WE_WKx is calculated by focusing on these factors that affect the work efficiency WE_WKx. Then, the work efficiency WE_WWL is calculated using the index IN_WE_WKx.

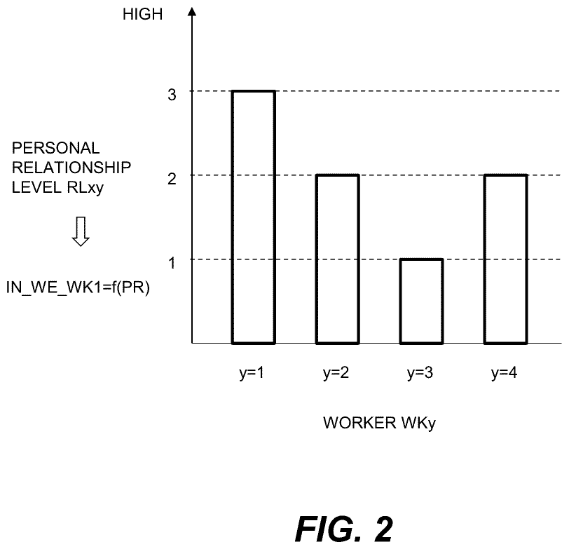

FIG. 2 is a diagram for illustrating a calculation example of the index IN_WE_WKx. FIG. 2 shows an example of the relationship level RLxy between the worker WKx (the worker WKx is a worker other than the workers WK1 to WK4) and the worker WKy. The relationship level RLxy is calculated based on a calculation formula in which the personal attribute AT of the worker WKx and the personal attribute AT of the worker WKy are variables, for example. The calculation of the index IN_WE_WKx is different depending on whether there is a relationship between the work content WC_WKx and the work content WC_WKy. In the former case, the relationship level RLxy is used as a variable for calculating the index IN_WE_WKx.

Specifically, when there is no relation between the work content WC_WKx and the work content WC_WKy, the index IN_WE_WKx is calculated by calculation using a variable PR (e.g., a fatigue level, a concentration, an arousal level, or the like of the worker WKy) which has a correlation with the work efficiency WE_WKx and can express the degree thereof by a numerical value (IN_WE_WKx=f(PR)). On the other hand, when there is a relationship between the work content WC_WKx and the work content WC_WKy, the relationship level RLxy calculated based on the personal attribute AT is added to the variable PR of this calculation.

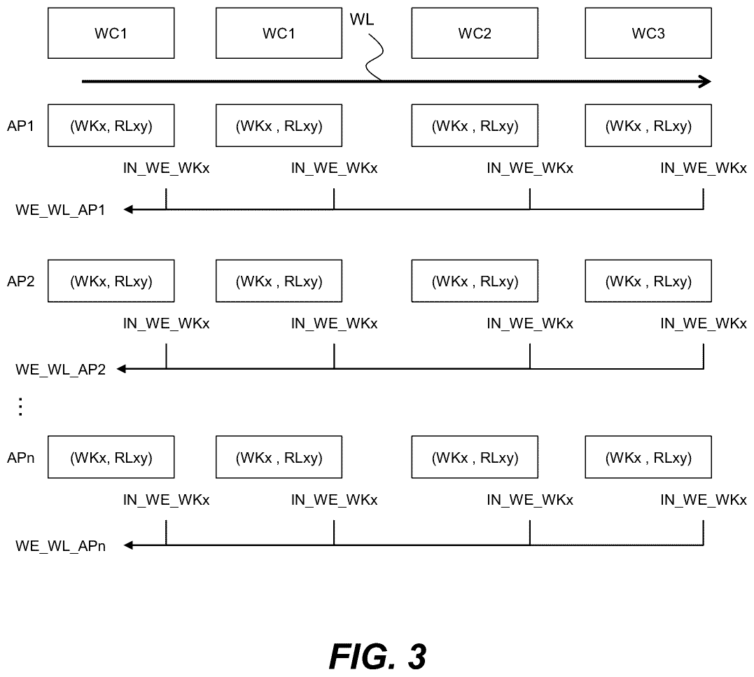

FIG. 3 is a diagram for illustrating an outline of the DTS according to the embodiment. As illustrated in FIG. 3, in the DTS according to the embodiment, the worker WKx is assigned to each of multiple works performed in cooperation with the work line WL. The multiple works have any one of the work content WCs. Therefore, the assignment of the worker WKx to each of the multiple works means that the worker WKx is distributed to any one of the work content WCs.

When all the tasks have been assigned worker WKx, the index IN_WE_WKx is calculated. Then, the work efficiency WE_WWL can be calculated based on the calculated index IN_WE_WKx. The work efficiency WE_WWL is calculated using, for example, a calculation formula in which the calculated index IN_WE_WKx is a variable (WE_WWL=IN_WE_WKx).

In the DTS according to the embodiment, the worker WKx is further assigned to multiple works for all the assumed pattern (assignment patterns of the worker WKx) APs (API to APn). In the example shown in FIG. 3, the index IN_WE_WKx is calculated for all the pattern APs, assuming that there is a relationship between the work content WC_WKx and the work content WC_WKy. The work efficiency WE_WWL is calculated for all the pattern APs (WE_WWL_AP1 to WE_WWL_APn).

When the work efficiency WE_WWL is calculated for all the pattern APs, the work efficiency WE_WWL is selected using the following reference condition.

Reference condition: Work efficiency WE_WWL is equal to or greater than a target value TG

Thus, a pattern AP satisfying the reference condition is specified. Note that a value separately set based on the work plan WP in the work line WL is applied to the target value TG.

In the DTS according to the embodiment, a search is performed to specify the pattern AP in which such a reference condition is satisfied. As a result of the search, when the pattern AP satisfying the reference condition is specified, if the work line WL of the real space is operated with reference to the pattern AP, it is expected that the work efficiency WE_WWL of the entire work line WL is increased.

In the embodiment, since the work line WL of the real space is operated with reference to the pattern AP specified by the DTS, “staff assignment processing” to arrange the worker WKx in the work line WL of the real space is performed using the result of the search by the DTS. Details of the staff assignment processing will be described later.

### 3. Other features of Embodiment

In the embodiment, as variables for calculating the relationship level RLxy, in addition to personal attribute AT of the worker WKx and personal attribute AT of the worker WKy, personal trait TA of the worker WKx and personal trait TA of the worker WKy may be used. The personal trait TA is determined using characteristic elements such as personality and sociability obtained through a questionnaire for multiple workers, for example. The personality is exemplified by a thought type, an activity type, an effort type, a positive type, an autistic type, and the like. The sociability is exemplified by aggressiveness, coordination, sense of responsibility, self-reliability, coaching, sympathy, emotional stability, compliance, moratorium tendency, and the like.

The personal attribute AT described in FIG. 1 is determined based on objective factors, whereas the personal trait TA is determined based on subjective factors. Further, while it is relatively easy to collect information necessary for determining personal attribute AT, it takes time to collect information necessary for determining personal trait TA. This is because a certain time is required for the relationship Rxy to be constructed, and the reliability of the information on the relationship Rxy is considered to be low until the certain time elapses. For this reason, in the embodiment, personal attribute AT is used as a variable essential for the calculation of the relationship level RLxy, and personal attribute AT is used as an arbitrary variable. However, after the information necessary for determining the personal attribute AT is sufficiently collected, it is expected that the accuracy of the calculation of the relationship level RLxy is increased by using the personal trait TA as the variable of the calculation of the relationship level RLxy.

In the embodiment, when there is a relationship between the work content WC_WKx and the work content WC_WKy, the relationship level RLxy is used as the variable PR for calculating the index IN_WE_WKx. As will be described in detail later, the work content WC_WKx and the work content WC_WKy are specified based on the work plan of the work line WL. Further, whether the work content WC_WKx and the work content WC_WKy are related to each other is determined based on the work plan. In this way, the relevance between the work content WC_WKx and the work content WC_WKy is easily determined based on the work plan, and thus the level of the relevance may be converted into a numerical value (data).

The level of the relevance between the work content WC_WKx and the work content WC_WKy is exemplified by a level of work (medium level) that requires a certain level of the relationship Rxy, a level of work (high level) that requires a certain level or more of the relationship Rxy, and a level of work (low level) that can be performed even in a personal relationship of less than a certain level. In the embodiment, the level of the relationship Rxy required in the work of the work content WC_WKx may be set based on the level of the relevance. Hereinafter, for convenience of description, the level of the relation Rxy required in the work of the work content WC_WKx is also referred to as a “required level RLRxy”.

In the description of the example of FIG. 3, the worker WKx is assigned to each of the multiple works performed in cooperation with the work line WL. However, in this assignment method, it is expected that the total number of assignment pattern APs becomes enormous. In this regard, if the required level RLRxy is set, the total number of assignment pattern APs can be reduced by using the following narrowing condition based on the required level RLRxy. This leads to a reduction in the processing load of the DTS. Narrowing condition: When the worker WKx is assigned to the work of work content WC_WKx, the worker WKy whose personal relationship level LRxy with the worker WKx is equal to or more than required level RLRxy is assigned to the work of work content WC_WKy.

### 3. Configuration Example

### 3-1. System Configuration Example

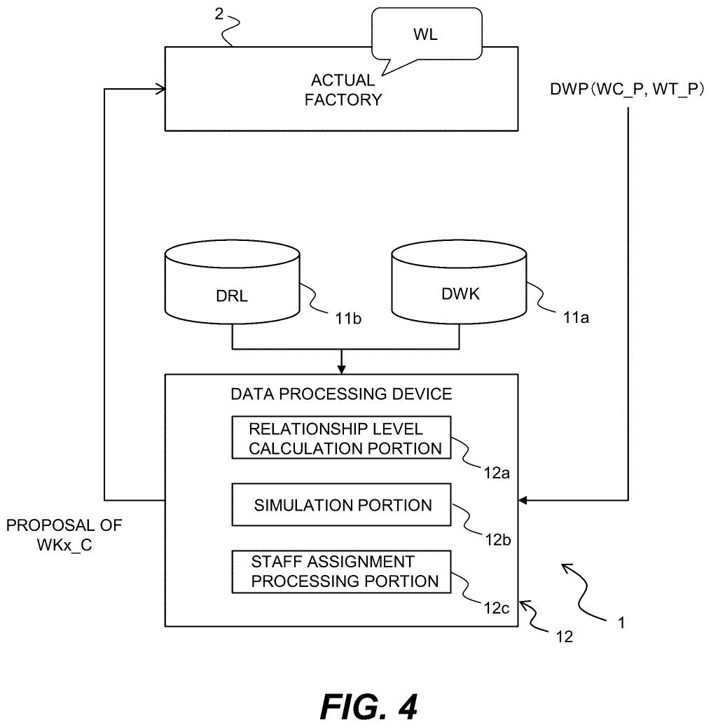

FIG. 4 is a diagram for illustrating a configuration example of the system according to the embodiment. The simulation system 1 shown in FIG. 4 includes a database 11 and a data processing device 12 as a configuration for performing a simulation (that is, digital twin simulation) using a digital space that reproduces a real space in the actual factory 2 in which the work line WL is provided.

The database 11 is formed inside a hard disk or a flash memory, for example. In the example shown in FIG. 4, the database 11 includes two types of databases 11a and 11b. The database 11a stores relationship level information DRL. The database 11b stores worker data DWK.

The relationship level data DRL represents data related to the relationship level RLxy. As described above, the relationship level RLxy represents the level of the relationship Rxy between the worker WKx and the worker WKy. As described above, the relationship level RLxy is calculated based on a calculation formula having the personal attribute AT of the worker WKx and the personal attribute AT of the worker WKy as variables. The relationship level RLxy is calculated for all of the multiple workers arranged on the work line WL. The relationship level RLxy is calculated, for example, each time the personal attribute AT of the worker WKx is updated. When personal trait TA is used for the calculation of the relationship level RLxy, the relationship level RLxy may be calculated each time personal trait TA is updated.

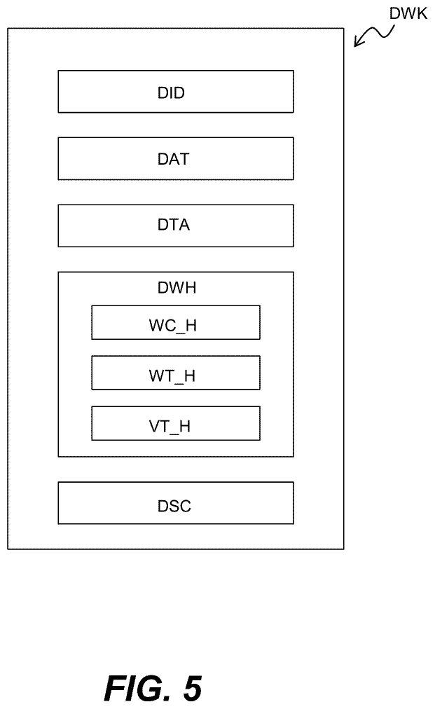

The worker data DWK represents data related to multiple workers arranged in the work line WL. The worker data DWK is also a set of data related to the worker WKx. FIG. 5 is a diagram for illustrating a configuration example of the worker data DWK. In the example shown in FIG. 5, the worker data DWK includes identification data DID, personal attribute data DAT, personal trait data DTA, work history data DWH, and schedule data DSC.

The identification data DID represents data for identifying the worker WKx. The personal attribute DAT represents the personal attribute AT of the worker WKx. As described above, the personal attribute AT is determined using the attributed elements including the public attributes such as the position, the number of years of work, and the type of employment of the worker WKx in the organization managing the work line WL, and the private attributes such as age, sex, family structure, home address, and hometown. The personal trait TA DTA represents personal traits of the worker WKx. As described above, the personal trait TA is determined using the characterizing factors such as personality and sociability obtained through the questionnaire for multiple workers.

The work history data DWH represents data relating to the work history of the worker WKx. In the example illustrated in FIG. 5, the work history data DWH includes work content data WC_H, work time data WT_H, and vital data VT_H.

The work content data WC_H represents history data of the works of the work content WCs in which the worker WKx is engaged. The work time data WT_H represents history data of the time when the worker WKx engaged in the work of the work content WC. The work time data WT_H is generated for each work content WC. The vital data VT_H represents data relating to the physical condition of the worker WKx, such as pulse, blood pressure, and body temperature. The vital data VT_H is acquired from, for example, a measurement tool worn by the worker WKx. Like the work time data WT_H, the vital data VT_H is generated for each work content WCs.

The schedule data DSC represents data related to the schedule SC of the worker WKx. The schedule SC of the worker WKx is, for example, a work schedule of the worker WKx for a certain period (for example, one day, one week, or one month). The work schedule includes information such as a time zone in which the work content WCs are scheduled to be arranged in the work line WL, a time zone in which the work content WCs are scheduled to be engaged in a task other than the work content WCs in the work line WL, and a time zone in which the work content WCs are scheduled to take a break.

The data processing device 12 is a computer including at least one processing circuitry and at least one memory device. The at least one processing circuitry includes a central processing unit (CPU). At least one memory device stores a program for executing the calculation processing of the relationship level RLxy, the DTS, the staff assignment processing, and other data processes. These programs may be stored in a recording medium readable by the data processing device 12.

### 3-2. Function Configuration Example of Data Processing Device

In FIG. 4, a relationship level calculation unit 12a, a simulation unit 12b, and a staff assignment processing unit 12c are depicted as functions of the data processing device 12. These functions are realized by the processing circuitry of the data processing device 12 executing various programs stored in the memory device of the data processing device 12.

The relationship level calculation unit 12a performs a calculation process of the relationship level RLxy. In this calculation process, the relationship level RLxy is calculated based on the worker data DWK (i.e., personal attribute DAT) stored in the database 11b. As described above, the relationship level RLxy is calculated based on a calculation formula in which the personal attribute AT of the worker WKx and the personal attribute AT of the worker WKy are variables, for example. In the calculation process, the relationship level RLxy may be calculated based on the worker data DWK (i.e., the personal attribute DAT and the personal trait DTA) stored in the database 11b.

The simulation unit 12b executes the DTS. In this DTS, first, a worker WKx is assigned to each of multiple works being executed in the work line WL. The worker WKx may be assigned to each of the multiple works scheduled to be executed in the work line WL.

The work content WCs of the multiple works to be performed in the work line WL and the work content WCs of the multiple works to be performed in the work line WL are specified from the work plan data DWP of the work line WL. Here, the work plan data DWP is separately set by, for example, a computer included in the actual factory 2. The work plan data DWP includes, for example, data of work content WC_P being performed (or scheduled to be performed) in the work line WL and data of time WT_P for performing (or scheduled to be performed) the work of the work content WC_P. Therefore, by referring to the data of the work content WC_P, the work content WCs of the multiple works (that is, the work content WC_WKx and the work content WC_WKy) are specified.

When the worker WK is assigned to each of the multiple works, the index IN_ WE_WKx in the assignment pattern AP is calculated. Further, the work efficiency WE_WWL is calculated based on the index IN_WE_WKx. As described above, the calculation of the index IN_WE_WKx is performed using the variable PR (for example, the fatigue level, the concentration level, the arousal level, or the like of the worker WKy). If there is a relationship between work content WC_WKx and work content WC_WKy, relationship level RLxy is added to the variable PR of this calculation. The relationship level RLxy is specified by referring to the database 11a using the worker WKx and the worker WKy.

The calculation of the index IN_WE_WKx and the calculation of the work efficiency WE_WWL based on the index IN_WE_WKx are performed for all the assumed assignment pattern APs. When the work efficiency WE_WWL is calculated for all the pattern APs, these work efficiency WE_WWL are selected using the reference condition. In this way, in the DTS, the assignment pattern AP corresponding to the work efficiency WE_WWL satisfying the reference condition is searched. As a result of the selection using the reference condition, two or more patterns of assignment pattern AP corresponding to work efficiency WE_WWL satisfying the reference condition may remain. In this case, it is desirable to select these pattern APs and arrange these pattern APs in the order in which the score of work efficiency WE_WWL is in descending order, because this is in accordance with the object of the present disclosure.

Since the work content WCs of the multiple works (that is, the work content WC_WKx and the work content WC_WKy) are specified by referring to the data of the work content WC_P, the assignment pattern AP may be narrowed down before the index IN_WE_WKx is calculated for all the assumed assignment pattern APs. To be more specific, the required level RLRxy may be set based on the level of the relationship between the work content WC_WKx and the work content WC_WKy, which is specified by referring to the work content WC_P. Then, the required level RLRxy is applied to the above-described narrowing-down condition. Thus, the assignment pattern APs of the worker WKx and the worker WKy having the relationship level RLxy less than the required level RLRxy are excluded, and thus the total number of assignment pattern APs can be reduced.

The staff assignment processing unit 12c executes staff assignment processing for arranging workers on the work line WL of the real space. In the staff assignment processing, a candidate WKx_C of the worker WKx assigned to each of the multiple works scheduled to be executed in the work line WL is selected with reference to the search result by the DTS. Thus, the candidate WKx_C is proposed. The proposal of the candidate WKx_C is performed, for example, by outputting data of the candidate WKx_C on an UI (user interface) of the work line WL. The decision to adopt this proposal is made by, for example, the person in charge of the work line WL in real space.

The multiple works to be executed in the work line WL are specified from the work plan data DWP of the work line WL. As described above, the work plan data DWP includes data of the work content WC_P scheduled to be executed in the work line WL and data of the time WT_P scheduled to execute the work of the work content WC_P. Therefore, by referring to the data of the work content WC_P, the multiple works to be executed and the work content WCs of these works are specified.

When multiple works to be executed in the work line WL and the work content WCs of these works are specified, the candidate WKx_C is specified. For example, the data of the time WT_P included in the work plan data DWP and the schedule data DSC are referred to, and the candidate WKx_C whose time zone of the arrangement schedule to the work line WL overlaps the time zone of the time WT_P is specified. The number of persons of the candidate WKx_C specified at this stage is normally two or more.

When the candidate WKx_C is specified, the candidate WKx_C and the search result by the DTS are referred to. According to the search by the DTS, the assignment pattern AP corresponding to the work efficiency WE_WWL satisfying the reference condition is selected. Therefore, if the worker WKx constituting the assignment pattern AP is included in the candidate WKx_C specified by referring to the schedule data DSC, the worker WKx is specified as the candidate WKx_C.

When there are two or more patterns of assignment pattern APs corresponding to the work efficiency WE_WWL satisfying the reference condition, the schedule data DSC is referred to in order from the assignment pattern AP having the highest score of the work efficiency WE_WWL. Therefore, for example, when the work schedules of some or all workers WKx constituting the assignment pattern AP having the highest work efficiency WE_WWL do not match the work plan of the work line WL, it is possible to examine the assignment pattern AP having the second highest work efficiency WE_WWL. By performing the reference in such an order, it is possible to suppress a situation in which the candidate WKx_C cannot be selected. At the same time, the candidate WKx_C can be selected based on the assignment pattern AP having a higher score of the work efficiency WE_WWL.

In the case where there is only one assignment pattern AP corresponding to the work efficiency WE_WWL satisfying the reference condition, when the work schedules of some workers WKx constituting the assignment pattern AP do not match the work plan of the work line WL, the personal attribute ATs of the multiple workers constituting the assignment pattern AP may be referred to. By referring to the personal attribute DAT, it is possible to identify, as a candidate WKx_C, another worker WKx who has the same personal attribute AT as the personal attribute AT of the worker WKx who does not match the work plan of the work line WL and whose work schedule matches the work plan of the work line WL. The personal attribute DAT is stored in the database 11b.

Even when there are two or more patterns of assignment pattern AP corresponding to work efficiency WE_WWL satisfying the reference condition, the personal attribute data DAT may be referred to. For example, when the work schedules of some or all workers WKx constituting the group CG of the assignment pattern AP having the highest score of the work efficiency WE_WWL do not match the work plan of the work line WL, the personal attribute data DAT is referred to. As a result, another worker WKx who has the same personal attribute AT as the personal attribute AT of the worker WKx who does not match the work plan and has a work schedule that matches the work plan of the work line WL can be identified as the candidate WKx_C.

### 4. Effect

According to the embodiment described above, it is possible to specify the assignment pattern AP when the reference condition is satisfied in the DTS. Then, when the work line WL of the real space is operated with reference to the specified assignment pattern AP, it is expected that the work efficiency WE_WWL of the entire work line WL is increased.

What is claimed is:

1. A simulation system, comprising:
a database in which data of multiple workers arranged in a work line of a real space; and
a processing circuitry configured to execute a simulation on a work line of a digital space corresponding to that of the real space based on data of a work plan in the work line of the real space and data stored in the database,
wherein the data of the multiple workers stored in the database includes data of personal attributes of the multiple workers and data of a personal relationship level between two workers included in the multiple workers, the data of a personal relationship level is calculated based on the data of the personal attributes,
wherein the data of the work plan in the work line of the real space includes data of work contents of works scheduled to be performed in the work line of the real space,
wherein, in the simulation, the processing circuitry is configured to search for an assignment pattern of workers satisfying a reference condition in which a work efficiency in a whole work line of the digital space is equal to or greater than a target value, based on the data of the work contents of works to be performed and data related to the personal relationship level between the two workers.

2. The simulation system according to claim 1,
wherein the data of the multiple workers stored in the database further includes data of personal traits of the multiple workers, and
wherein the personal relationship level between the two workers is calculated based on the data related to the personal attribute and the data related to the personal trait.

3. The simulation system according to claim 1,
wherein the data of the work contents of the works to be performed includes data of a level of a relevance of the work contents performed by each of the two workers, and
wherein, in the simulation, the processing circuitry is further configured to set a personal relationship level required in the work to be performed for each of the works to be performed based on the data of the level of relevance, and
wherein, in the simulation, the search for the assignment pattern of the workers is executed based on the personal relationship level between the two workers and a personal relationship level required in the work to be performed.

4. The simulation system according to claim 1,
wherein the processing circuitry further configured to execute staff assignment processing to arrange workers in the work line of the real space,
wherein, in the staff assignment processing, the processing circuitry is configured to select multiple workers to be arranged in the work line of the real space by referring to data of a schedule of the workers scheduled to be arranged in the work line of the real space by using a search result by the simulation.

5. The simulation system according to claim 4,
wherein, when the search result obtained by the simulation includes two or more patterns of assignment patterns of workers satisfying the reference condition, the staff assignment processing executes the reference using data of the schedule of the workers to be arranged in order from an assignment pattern of a worker having a high work efficiency in the whole work line.

6. A non-transitory computer-readable medium storing a simulation program, the simulation program causing a computer to execute a simulation in a work line of a digital space corresponding to a work line of a real space,
wherein, in the simulation, an assignment pattern of workers satisfying a reference condition that a work efficiency in a whole work line of the digital space is equal to or more than a target value is searched for based on data of work contents of works scheduled to be performed in the work line of the real space and data of a personal relationship level between two workers included in multiple workers arranged in the work line of the real space, the data of the work contents being calculated based on data related to personal attributes of the multiple workers.
